(19) United States
(12) Patent Application Publication
(10) Pub. No.: US 2025/0035777 A1
(43) Pub. Date: Jan. 30, 2025

(54) INFRASTRUCTURE RADIO WAVE SENSOR

(71) Applicant: Sumitomo Electric Industries, Ltd., Osaka-shi, Osaka (JP)

(72) Inventor: Hideaki SHIRANAGA, Osaka-shi, Osaka (JP)

(73) Assignee: Sumitomo Electric Industries, Ltd., Osaka-shi, Osaka (JP)

(21) Appl. No.: 18/716,516

(22) PCT Filed: Nov. 25, 2022
(86) PCT No.: PCT/JP2022/043471

§ 371 Date: Jun. 5, 2024

(30) Foreign Application Priority Data
Dec. 17, 2021 (JP) 2021-204800

(51) Int. Cl. G01S 13/91; G01S 7/40

(52) U.S. Cl. CPC G01S 13/91; G01S 7/40

(57) ABSTRACT

An infrastructure radio wave sensor includes: circuitry that, based on reflected waves that are radio waves emitted to a first object that is constantly present and a second object different from the first object and that are reflected from the first object and the second object, generate first reflected wave data representing information including a signal level of the reflected waves, detect the second object based on reference data representing information including a position of the first object and the first reflected wave data, detect a first abnormality that is an abnormality in a detection result obtained by the circuitry, and, in a case where the circuitry detects the first abnormality.

### TECHNICAL FIELD

The present disclosure relates to an infrastructure radio wave sensor. The present application claims priority under Japanese Patent Application No. 2021-204800, filed on Dec. 17, 2021, the entire contents of which are hereby incorporated by reference herein.

### BACKGROUND ART

PTL 1 discloses a vehicle-mounted radar apparatus that detects abnormalities in the event of decreased sensitivity of the radar apparatus or malfunction of a transmission/reception circuit while the vehicle is traveling.

### CITATION LIST

### Patent Literature

PTL 1: Japanese Unexamined Patent Application Publication No. 2000-227473

### SUMMARY OF INVENTION

An infrastructure radio wave sensor according to an aspect of the present disclosure includes: a generation unit that, based on reflected waves that are radio waves emitted to a first object that is constantly present and a second object different from the first object and that are reflected from the first object and the second object, generates first reflected wave data representing information including a signal level of the reflected waves; an object detection unit that detects the second object based on reference data representing information including a position of the first object and the first reflected wave data; an abnormality detection unit that detects a first abnormality that is an abnormality in a detection result obtained by the object detection unit; and a recover unit that, in a case where the abnormality detection unit detects the first abnormality, executes a recovery process for recovering from the first abnormality, wherein the generation unit newly generates second reflected wave data based on reflected waves of radio waves emitted after the abnormality detection unit detects the first abnormality, and the recovery process is a process of updating the reference data based on the second reflected wave data.

### BRIEF DESCRIPTION OF THE DRAWINGS

FIG. 1 is a diagram illustrating an example of the use of an infrastructure radio wave sensor according to an embodiment.

FIG. 2 is a perspective view illustrating an example of an exterior configuration of the infrastructure radio wave sensor according to the embodiment.

FIG. 3 is a block diagram illustrating an example of an internal configuration of the infrastructure radio wave sensor according to the embodiment.

FIG. 4 is a functional block diagram illustrating an example of the functions of the infrastructure radio wave sensor according to the embodiment.

FIG. 5A is a diagram illustrating an example of a detection area of the infrastructure radio wave sensor.

FIG. 5B is a diagram for explaining reflected wave data obtained by emitting radio waves to the detection area illustrated in FIG. 5A.

FIG. 6 is a diagram for explaining an example of first reference data.

FIG. 7A is a diagram illustrating an example of the detection area when the number of stationary objects increases.

FIG. 7B is a diagram for explaining reflected wave data obtained by emitting radio waves to the detection area illustrated in FIG. 7A.

FIG. 7C is a diagram for explaining an example of second reference data.

FIG. 8A is a flowchart illustrating a portion of an example of a process of determining a reflected wave data abnormality or a detection state abnormality by the infrastructure radio wave sensor according to the embodiment.

FIG. 8B is a flowchart illustrating another portion of the example of the process of determining a reflected wave data abnormality or a detection state abnormality by the infrastructure radio wave sensor according to the embodiment.

FIG. 9 is a flowchart illustrating an example of a first determination process.

FIG. 10 is a flowchart illustrating an example of a second determination process.

FIG. 11A is a flowchart illustrating a portion of an example of a module abnormality determination process by the infrastructure radio wave sensor according to the embodiment.

FIG. 11B is a flowchart illustrating another portion of the example of the module abnormality determination process by the infrastructure radio wave sensor according to the embodiment.

### DESCRIPTION OF EMBODIMENTS

### Problems to be Solved by Present Disclosure

Unlike vehicle-mounted radio wave sensors, infrastructure radio wave sensors used for traffic monitoring are fixed to structures (arms, etc.) installed on the road, and their detection areas are each a fixed point of the road. Such an infrastructure radio wave sensor is sometimes unable to detect objects (vehicles, people, etc.) normally due to dirt adhering to the transmission and reception surface of radio waves, positional or angular misalignment of the infrastructure radio wave sensor, construction of buildings in the detection area, and so forth. If there is a delay in recovery of the infrastructure radio wave sensor from an abnormality, accurate traffic monitoring is hindered.

### Advantageous Effects of Present Disclosure

According to the present disclosure, an infrastructure radio wave sensor can recover from an abnormality.

### Overview of Embodiments of Present Disclosure

An overview of an embodiment of the present disclosure will be set forth below.
(1) An infrastructure radio wave sensor includes: a generation unit that, based on reflected waves that are radio waves emitted to a first object that is constantly present and a second object different from the first object and that are reflected from the first object and the second object, generates first reflected wave data representing information including a signal level of the reflected waves; an object detection unit that detects the second object based on reference data representing information including a position of the first object and the first reflected wave data; an abnormality detection unit that detects a first abnormality that is an abnormality in a detection result obtained by the object detection unit; and a recover unit that, in a case where the abnormality detection unit detects the first abnormality, executes a recovery process for recovering from the first abnormality, wherein the generation unit newly generates second reflected wave data based on reflected waves of radio waves emitted after the abnormality detection unit detects the first abnormality, and the recovery process is a process of updating the reference data based on the second reflected wave data.

According to this configuration, if an abnormality occurs in the infrastructure radio wave sensor, the infrastructure radio wave sensor can recover from the abnormality by updating the reference data.
(2) The infrastructure radio wave sensor may further include a determination unit that, in a case where the recovery process is executed, executes a second determination process of determining whether recovery from the first abnormality has succeeded or failed.

According to this configuration, it can be determined whether or not the infrastructure radio wave sensor has been able to recover from the abnormality by updating the reference data.
(3) The determination unit may determine, in the second determination process, whether the recovery from the first abnormality has succeeded or not, based on a detection result before the reference data is updated and a detection result after the reference data is updated.

According to this configuration, it can be determined whether or not the infrastructure radio wave sensor has successfully recovered from the abnormality because the state of a detection target is different before the occurrence of the abnormality and after execution of the recovery process.
(4) The determination unit may execute a first determination process of determining whether the recovery from the first abnormality has failed or not, based on third reflected wave data newly generated by the generation unit since execution of the recovery process, and execute the second determination process in a case where it is determined in the first determination process that the recovery from the first abnormality has not failed.

According to this configuration, it is possible to more accurately determine whether or not the infrastructure radio wave sensor has been able to recover from the abnormality based on both the situation of the reflection of the radio waves and the state of the detection target before the occurrence of the abnormality and after the execution of the recovery process.
(5) The determination unit may determine, in the first determination process, that the recovery from the first abnormality has failed in a case where a signal level of reflected waves in at least a portion of the third reflected wave data continuous, for a certain period of time, to be a first value or more or a second value or less.

According to this configuration, the fact that the infrastructure radio wave sensor has failed to recover from the abnormality can be more accurately determined.
(6) The infrastructure radio wave sensor may further include a plurality of modules, wherein the abnormality detection unit is capable of detecting a second abnormality that is an abnormality in at least one or some of the plurality of modules, and, in a case where the abnormality detection unit detects the second abnormality, the recover unit may execute a partial reset process of resetting the module(s) in which the second abnormality has been detected.

According to this configuration, if an abnormality occurs in some module(s), the infrastructure radio wave sensor can recover promptly from the abnormality by resetting the module(s).
(7) The recover unit may further execute an entire reset process of resetting the entire infrastructure radio wave sensor in a case where the second abnormality is not resolved after the partial reset process.

According to this configuration, an abnormality that cannot be resolved by the partial reset process can be resolved by the entire reset process.
(8) The plurality of modules may include a transmission circuit that transmits the radio waves, a reception circuit that receives the reflected waves, and a clock generation circuit that transmits a clock signal to the transmission circuit and the reception circuit.

According to this configuration, if an abnormality occurs in the transmission circuit, the reception circuit, and the clock generation circuit of the infrastructure radio wave sensor, the infrastructure radio wave sensor can recover from the abnormality.
(9) The infrastructure radio wave sensor may further include a record unit that, in a case where the abnormality detection unit detects an abnormality including at least one of the first abnormality or the second abnormality, records abnormality information regarding the abnormality, wherein the record unit may record the abnormality information including a method of recovery in a case where recovery from the abnormality is performed by the recover unit.
(10) The infrastructure radio wave sensor may further include a notification unit that, in a case where the determination unit determines that the recovery from the abnormality has failed, notifies a user that the recovery from the abnormality has failed.
(11) The notification unit may notify the user of an occurrence of the first abnormality, notify the user that a recovery operation from the abnormality is in progress during execution of the second determination process, and, in a case where it is determined in the first determination process that the recovery from the abnormality has failed or in a case where it is determined in the second determination process that the recovery from the abnormality has failed, notify the user that the recovery from the abnormality has failed.
(12) The notification unit may notify the user of a normal state in a case where it is determined in the second determination process that the recovery from the first abnormality has succeeded.
(13) The infrastructure radio wave sensor may further include a notification unit configured to notify the user of an occurrence of the second abnormality, wherein the notification unit may be configured to notify the user that the partial reset process is in progress during execution of the partial reset process.

### Details of Embodiments of Present Disclosure

Hereinafter, details of an embodiment of the present disclosure will be described with reference to the drawings. Note that at least some portions of the embodiment described below may be optionally combined.

### [1. Traffic Monitoring System]

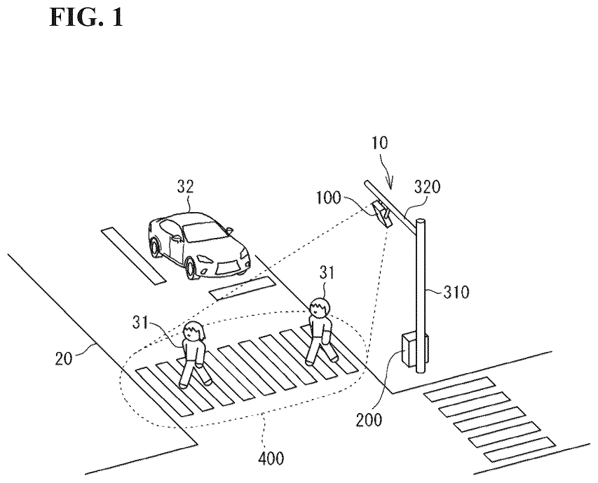

FIG. 1 is a diagram illustrating an example of the use of an infrastructure radio wave sensor according to the embodiment. An infrastructure radio wave sensor 100 according to the present embodiment is a radio wave radar for traffic monitoring. The infrastructure radio wave sensor 100 is, for example, a millimeter wave radar. The infrastructure radio wave sensor 100 is attached to an arm 320 connected to a pole 310, which is a stationary object provided on a road 20. The infrastructure radio wave sensor 100 detects an object (e.g., pedestrians 31 and/or a vehicle 32) in a detection area 400 on the road 20 by emitting radio waves (millimeter waves) to the detection area 400 and receiving reflected waves thereof. More specifically, the infrastructure radio wave sensor 100 can detect a distance from the infrastructure radio wave sensor 100 to an object traveling on the road, a velocity of the object, and a horizontal angle (azimuth) at a position where the object is present relative to the axis of radio wave emittance to the object.

A traffic monitoring system (object detection system) 10 includes the infrastructure radio wave sensor 100 and a control apparatus 200. The control apparatus 200 is located on the ground surface by the side of the road 20. The control apparatus 200 and the infrastructure radio wave sensor 100 are connected by a cable that is not illustrated. The infrastructure radio wave sensor 100 can transmit data of the detection result (hereinafter also referred to as “detection data”), data that notifies the state of the infrastructure radio wave sensor 100 (hereinafter also referred to as “state notification data”), and the like to the control apparatus 200.

### [2. Configuration of Infrastructure Radio Wave Sensor]

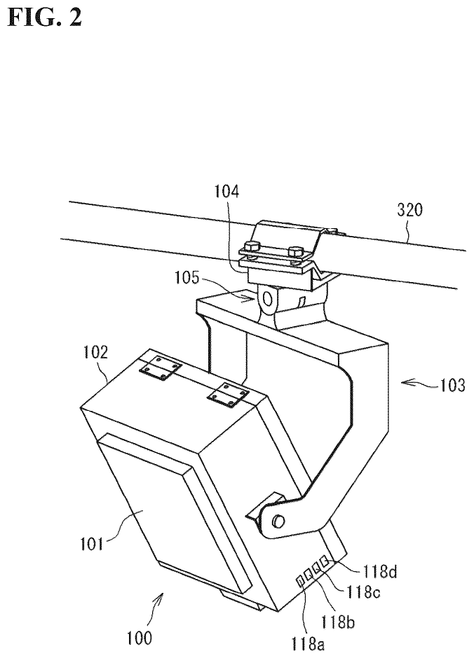

FIG. 2 is a perspective view illustrating an example of an exterior configuration of the infrastructure radio wave sensor 100 according to the embodiment. As illustrated in FIG. 2, the infrastructure radio wave sensor 100 has a transmission and reception surface 101, which transmits and receives millimeter waves. The infrastructure radio wave sensor 100 incorporates at least one transmission antenna and at least one reception antenna. The infrastructure radio wave sensor 100 transmits modulated waves, which are millimeter waves, from the transmission antenna through the transmission and reception surface 101. The modulated waves hit an object and are reflected, and the reception antenna receives the reflected waves. The infrastructure radio wave sensor 100 applies signal processing on the transmission wave signal and the reception wave signal to detect the distance to the object, the azimuth, and the velocity of the object.

The infrastructure radio wave sensor 100 is configured to be able to adjust its installation angle. The infrastructure radio wave sensor 100 includes a sensor body 102, a depression angle adjustment unit 103, a horizontal angle adjustment unit 104, and a roll angle adjustment unit 105. The sensor body 102 is formed in a box shape, and the depression angle adjustment unit 103 is attached to the side of the sensor body 102. The sensor body 102 is rotatable about the horizontal axis by the depression angle adjustment unit 103, thereby adjusting the depression angle of the sensor body 102. The sensor body 102 connected to the roll angle adjustment unit 105 with the depression angle adjustment unit 103 interposed therebetween is rotatable in the left-right direction by the roll angle adjustment unit 105, thereby adjusting the roll angle of the sensor body 102. The horizontal angle adjustment unit 104 is fixed to the pole 310, which is the target for installation. The sensor body 102 connected to the horizontal angle adjustment unit 104 with the depression angle adjustment unit 103 and the roll angle adjustment unit 105 interposed therebetween is rotatable about the vertical axis by the horizontal angle adjustment unit 104, thereby adjusting the horizontal angle of the sensor body 102.

The sensor body 102 is provided with a plurality of LEDs (Light Emitting Diode) 118a, 118b, 118c, and 118d. The LED 118a emits light when the infrastructure radio wave sensor 100 is functioning normally. The LED 118b emits light when a portion of the circuitry of the infrastructure radio wave sensor 100 is being reset. The LED 118c emits light during execution of a recovery operation from an abnormality. The LED 118d emits light when the infrastructure radio wave sensor 100 fails to recover from an abnormality.

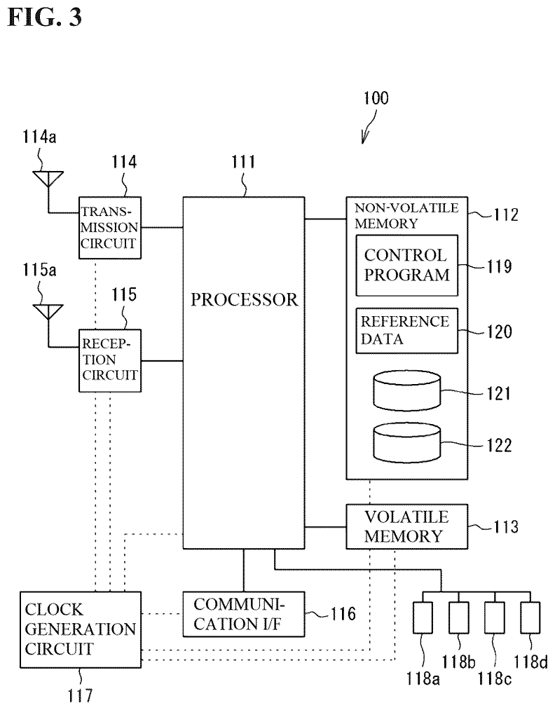

FIG. 3 is a block diagram illustrating an example of an internal configuration of the infrastructure radio wave sensor according to the embodiment. The infrastructure radio wave sensor 100 includes a processor 111, a non-volatile memory 112, a volatile memory 113, a transmission circuit 114, a reception circuit 115, a communication interface (communication I/F) 116, a clock generation circuit 117, and the LEDs 118a, 118b, 118c, and 118d.

The volatile memory 113 is, for example, a semiconductor memory such as SRAM (Static Random Access Memory) or DRAM (Dynamic Random Access Memory). The non-volatile memory 112 is, for example, flash memory, a hard disk, or ROM (Read Only Memory). The non-volatile memory 112 stores a control program 119, which is a computer program, and first reference data 120 used to execute the control program 119. The infrastructure radio wave sensor 100 is configured with a computer, and each function of the infrastructure radio wave sensor 100 is implemented by the processor 111 executing the control program 119, which is a computer program stored in a storage device of the computer. The control program 119 can be stored on a recording medium such as flash memory, ROM, CD-ROM, etc. The processor 111 can detect an abnormality in the infrastructure radio wave sensor 100 by the control program 119 and execute a recovery process from the abnormality.

The processor 111 is, for example, a CPU (Central Processing Unit). However, the processor 111 is not limited to a CPU. The processor 111 may be a GPU (Graphics Processing Unit). The processor 111 may be, for example, an ASIC (Application Specific Integrated Circuit) or a programmable logic device such as a gate array or an FPGA (Field Programmable Gate Array). In this case, an ASIC or a programmable logic device is configured to be able to execute processing identical or similar to the control program 119.

The transmission circuit 114 includes a transmission antenna 114a. Note that the number of transmission antennas 114a is not limited to one, and may be plural. The transmission circuit 114 generates modulated waves and transmits the generated modulated waves from the transmission antenna 114a. The transmitted modulated waves reflect off an object (e.g., the pedestrians 31 and/or the vehicle 32).

The reception circuit 115 includes a plurality of reception antennas 115a. The reception circuit 115 applies signal processing on the received reflected waves. Reflected wave data generated by the signal processing is provided to the processor 111. The processor 111 analyzes the reflected wave data to detect the position (distance and azimuth) and velocity of the object. The processor 111 writes the detection result of the object to the non-volatile memory 112 or the volatile memory 113.

The communication I/F 116 can communicate with an external apparatus. The communication I/F 116 is connected to the control apparatus 200 via a cable and can transmit detected data, state notification data, and the like to the control apparatus 200. For example, the communication I/F 116 may include a wireless communication interface for DSRC (Dedicated Short Range Communications). The communication I/F 116 may transmit position information and velocity information of the object detected through road-to-vehicle communication to the vehicle 32 traveling on the road 20.

The clock generation circuit 117 transmits a clock signal to each of the processor 111, the non-volatile memory 112, the volatile memory 113, the transmission circuit 114, the reception circuit 115, and the communication I/F 116.

The processor 111 is connected to each of the LEDs 118a, 118b, 118c, and 118d. The processor 111 causes the LEDs 118a, 118b, 118c, and 118d to emit light in response to the state of the infrastructure radio wave sensor 100.

The transmission circuit 114, the reception circuit 115, and the clock generation circuit 117 have the function of detecting abnormalities in the circuitry. For example, the transmission circuit 114 includes a monitoring circuit for transmission power, and, with the monitoring circuit, is capable of detecting abnormalities in the transmission power. For example, the reception circuit 115 includes a current monitoring circuit, and is capable of detecting abnormalities in the bias current of the reception circuit 115. For example, the clock generation circuit 117 includes a PLL (Phase Locked Loop), and is capable of detecting a lockout of the PLL. The transmission circuit 114, the reception circuit 115, and the clock generation circuit 117 are capable of notifying the processor 111 of abnormality detection.

The non-volatile memory 112 includes a detection result database (detection result DB) 121. The detection result DB 121 is a database that stores past object detection results.

The non-volatile memory 112 includes a log database (log DB) 122. The log DB 122 is a database that records the state information of the infrastructure radio wave sensor 100.

### [3. Functions of Infrastructure Radio Wave Sensor]

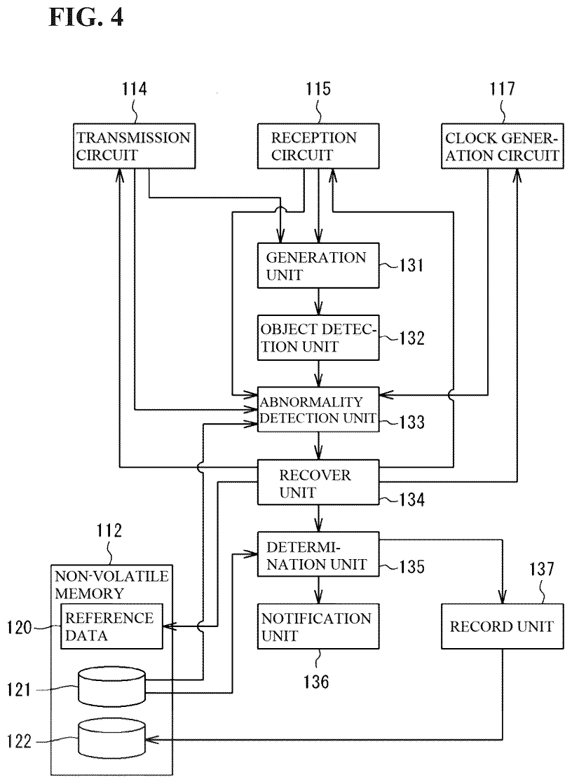

FIG. 4 is a functional block diagram illustrating an example of the functions of the infrastructure radio wave sensor 100 according to the embodiment. By the processor 111 executing the control program 119, the infrastructure radio wave sensor 100 performs the functions of a generation unit 131, an object detection unit 132, an abnormality detection unit 133, a recover unit 134, a determination unit 135, a notification unit 136, and a record unit 137.

The generation unit 131 generates, based on reflected waves that are radio waves emitted to an object and that are reflected from the object, reflected wave data representing information including the signal level of the reflected waves. The transmission circuit 114 transmits a transmission signal, which includes modulated waves, from the transmission antenna 114a. The transmission signal from the transmission antenna 114a reflects off the object. The reception antenna 115a receives reflected waves from the object. The generation unit 131 combines the modulated wave signal output from the transmission circuit 114 with the reflected wave signal output from the reception circuit 115 to generate an intermediate frequency signal (hereinafter referred to as “IF signal”). The generation unit 131 applies a high-speed Fourier transform (FFT) to the IF signal to obtain distance, velocity, and azimuth information. The generation unit 131 generates reflected wave data based on the obtained distance and azimuth information. The reflected wave data is, for example, data of the polar coordinate system with the distance from the infrastructure radio wave sensor 100 as the moving diameter and the angle from the direction of radio wave emittance as the deflection angle, and is data representing the reception level and phase of reflected waves for each coordinate position.

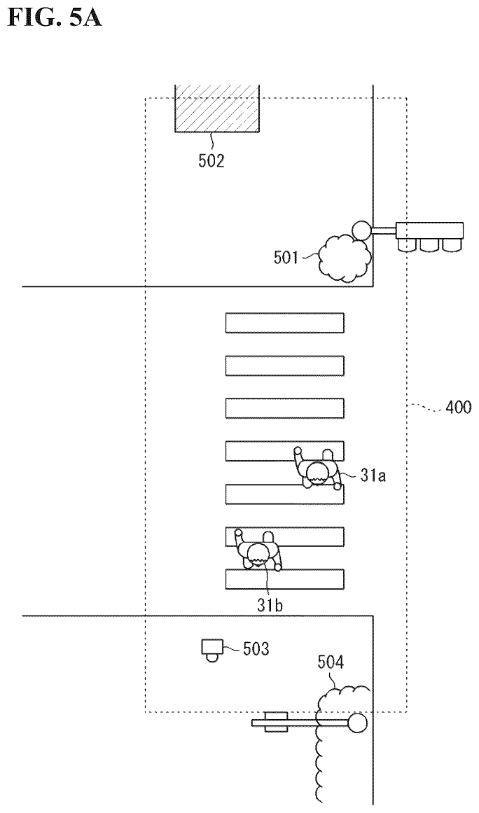

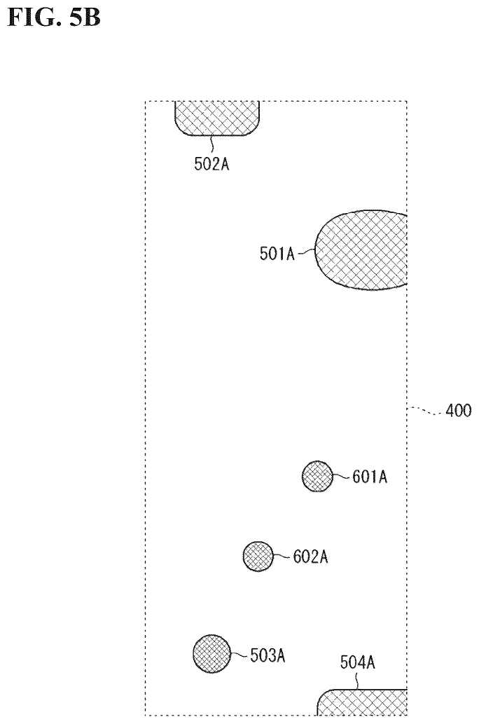

Based on the first reference data 120 representing information including the position of an object that is constantly present (first object) and reflected wave data generated by the generation unit 131, the object detection unit 132 detects an object (second object) different from the object constantly present. FIG. 5A is a diagram illustrating an example of the detection area 400 of the infrastructure radio wave sensor 100, and FIG. 5B is a diagram for explaining reflected wave data obtained by emitting radio waves to the detection area 400 illustrated in FIG. 5A. Note that in FIGS. 5A and 5B, the detection area 400 is a rectangle for simplicity of illustration.

The detection area 400 illustrated in FIG. 5A encompasses a crosswalk. In the detection area 400, there are a traffic light and plant 501, a building 502, a traffic light 503, and a plant 504 in the vicinity of the crosswalk. The traffic light and plant 501, the building 502, the traffic light 503, and the plant 504 are contained in the detection area 400. There are pedestrians 31a and 31b on the crosswalk.

The generation unit 131 calculates the position (distance and azimuth) of the traffic light and plant 501, the building 502, the traffic light 503, and the plant 504, as well as the pedestrians 31a and 31b in the detection area 400. Referring to FIG. 5B, the reflected wave data includes position information of detected objects 501A, 502A, 503A, 504A, 601A, and 602A. The detected object 501A corresponds to the traffic light and plant 501, the detected object 502A to the building 502, the detected object 503A to the traffic light 503, the detected object 504A to the plant 504, the detected object 601A to the pedestrian 31a, and the detected object 602A to the pedestrian 31b.

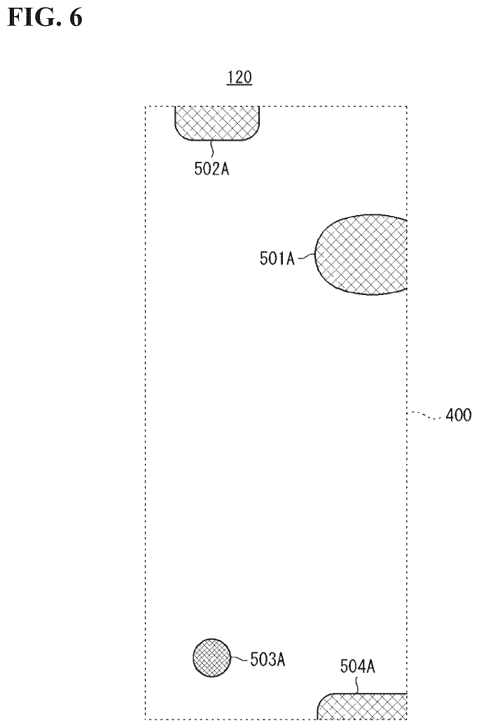

FIG. 6 is a diagram for explaining an example of first reference data. The first reference data 120 is reflected wave data obtained by emitting radio waves to the detection area 400 when there are no moving objects (pedestrians and vehicles). The first reference data 120 includes position information of objects that are constantly present in the detection area 400. In the example of FIG. 5A, the objects constantly present in the detection area 400 are the traffic light and plant 501, the building 502, the traffic light 503, and the plant 504. For this reason, the first reference data 120 includes the position information of the detected objects 501A, 502A, 503A, and 504A.

The object detection unit 132 compares the first reference data 120 with the reflected wave data to detect any moving object. Specifically, the object detection unit 132 calculates a difference between the first reference data 120 and the reflected wave data. The difference includes only the detected object 601A corresponding to the pedestrian 31a and the detected object 602A corresponding to the pedestrian 31b. In this way, the object detection unit 132 identifies the pedestrians 31a and 31b.

The abnormality detection unit 133 detects an abnormality in the detection result obtained by the object detection unit 132. Due to strong winds, vibrations, etc., the arm 320 may rotate around the pole 310 or the angle of the sensor body 102 may change, causing the position or angle of the infrastructure radio wave sensor 100 to be displaced. After the position of the infrastructure radio wave sensor 100 is displaced, the detection area 400 changes compared to before the position of the infrastructure radio wave sensor 100 is displaced. For example, when the transmission and reception surface 101 is facing the sky, there is no object in the detection area 400, and no reflected wave is received at the infrastructure radio wave sensor 100. The reception level of the reflected waves is near the lower limit value in the entire reflected wave data (the entire detection area 400). If a portion of the detection area 400 contains the sky, the reception level of the reflected waves is near the lower limit value in a portion of the reflected wave data. If the transmission and reception surface 101 is facing an obstacle, such as a traffic light, that reflects radio waves at a very high level, then reflected waves at a very high level are received from the obstacle in the detection area 400. The reception level of the reflected waves is near the upper limit value in at least a portion of the reflected wave data. If an obstacle is included in a portion of the detection area 400, the reception level of the reflected waves is near the upper limit value in a portion of the reflected wave data. The abnormality detection unit 133 analyzes the reflected wave data and, if the reception level of the reflected waves in at least a portion of the reflected wave data continues to be a first value or more for a certain period of time, determines that the reception level of the reflected waves in at least the portion of the reflected wave data is near the upper limit value, thus detecting an abnormality. The abnormality detection unit 133 analyzes the reflected wave data and, if the reception level of the reflected waves in at least a portion of the reflected wave data continues to be a second value or less for a certain period of time, determines that the reception level of the reflected waves in at least the portion of the reflected wave data is near the lower limit value, thus detecting an abnormality. Hereinafter, an abnormality detected by analyzing the reflected wave data is referred to as a “reflected wave data abnormality (first abnormality)”. Note that the first value is a value determined based on the upper limit value, and the second value is a value determined based on the lower limit value.

Increased or decreased stationary objects in the detection area 400, such as a newly built building, an old building demolished, or a construction vehicle stopped for an extended period of time, disables the infrastructure radio wave sensor 100 from detecting objects normally. The abnormality detection unit 133 can detect such abnormalities.

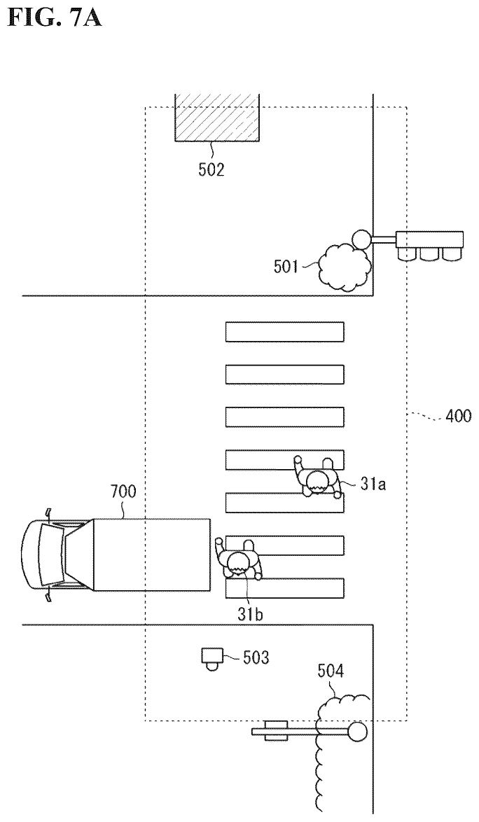

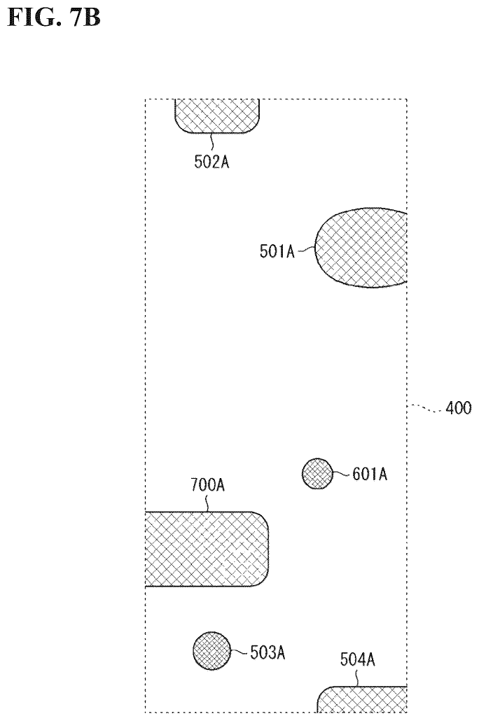

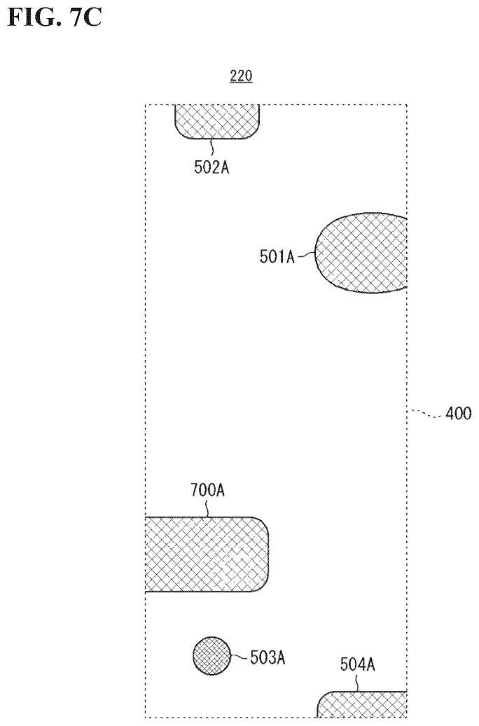

FIG. 7A is a diagram illustrating an example of the detection area 400 when the number of stationary objects increases. FIG. 7B is a diagram for explaining reflected wave data obtained by emitting radio waves to the detection area 400 illustrated in FIG. 7A. FIG. 7C is a diagram illustrating an example of second reference data. In the example of FIG. 7A, as compared to the example of FIG. 5A, there is an additional construction vehicle 700, which is an object stationary in the vicinity of the crosswalk.

Referring to FIG. 7B, a detected object 700A corresponds to the construction vehicle 700. The construction vehicle 700 is made of metal and has a high signal level of reflected waves. For this reason, reflected waves reflected from the construction vehicle 700 interfere with reflected waves of the pedestrian 31b in the vicinity of the construction vehicle 700, and the object detection unit 132 is no longer able to detect the pedestrian 31b. The abnormality detection unit 133 analyzes the reflected wave data. If there is a portion of the reflected waves that has a signal level that is the first value or more, the abnormality detection unit 133 determines that the portion is near the upper limit value, thus being able to detect an abnormality such as the one mentioned above. This abnormality is also one of the reflected wave data abnormalities.

As a result of the displacement of the infrastructure radio wave sensor 100, the transmission and reception surface 101 may be directed towards a location different from the places where vehicles or pedestrians are present, such as the road or the crosswalk. For example, when the transmission and reception surface 101 is directed towards a building, no moving object, such as the pedestrian 31 or the vehicle 32, is detected. As another example, when the angle of the transmission and reception surface 101 changes such that the detection area 400, which initially encompassed the entire crosswalk, now only partially covers it, the number of detections of the pedestrian 31 per unit time may decrease.

The abnormality detection unit 133 compares the number of object detections per unit time (e.g., one hour) by the object detection unit 132 with past performance values, and, if the number of object detections per unit time is significantly different from the performance values, detects an abnormality. Such abnormalities in the detection state by the object detection unit 132 are hereinafter referred to as “detection state abnormalities”. The past performance values are obtained from the detection result DB 121.

The abnormality detection unit 133 may compare the detection result obtained by the object detection unit 132 with past performance values in the same time period as the time period in which the detection result was obtained, and detect abnormalities. Furthermore, the abnormality detection unit 133 may compare the detection result obtained by the object detection unit 132 with past performance values on the same day of the week as the day on which the detection result was obtained, and detect abnormalities. This makes it possible to detect abnormalities more accurately.

If the state in which the number of object detections per unit time by the object detection unit 132 is a certain value or more continues for a certain period (e.g., one day), the abnormality detection unit 133 may determine frequent or sustained object detection states and detect an abnormality. If the state in which the number of object detections per unit time by the object detection unit 132 is a certain value or less continues for a certain period (e.g., one day), the abnormality detection unit 133 may determine frequent or sustained object undetected states and detect an abnormality. If the number of object detections per unit time by the object detection unit 132 falls within a certain range for a certain period (e.g., one day), the abnormality detection unit 133 may determine that the number of detections remains unchanged and detect an abnormality. Such abnormalities are also included in the detection state abnormalities.

As described above, the transmission circuit 114 can detect abnormalities in the transmission circuit 114. Upon detecting an abnormality, the transmission circuit 114 maintains state information representing the detected abnormality. Similarly, the reception circuit 115, upon detecting an abnormality in the reception circuit 115, maintains state information representing the detected abnormality. The clock generation circuit 117, upon detecting an abnormality in the clock generation circuit 117, maintains state information representing the detected abnormality. The abnormality detection unit 133 can detect abnormalities by checking the state information of the transmission circuit 114, the reception circuit 115, and the clock generation circuit 117. Hereinafter, such abnormalities in the transmission circuit 114, the reception circuit 115, and the clock generation circuit 117 are referred to as “module abnormalities (second abnormalities)”. The transmission circuit 114, the reception circuit 115, and the clock generation circuit 117 are examples of “modules”.

Referring back to FIG. 4, the recover unit 134 executes a recovery process for recovering from an abnormality in a case where the abnormality detection unit 133 detects an abnormality in a detection result obtained by the object detection unit 132. In the present embodiment, the recovery process includes a first recovery process and a second recovery process. The first recovery process is a process of updating the first reference data 120, and the second recovery process is a process of resetting a module in which an abnormality occurred.

If the abnormality detection unit 133 detects a reflected wave data abnormality or a detection state abnormality, the generation unit 131 generates new reflected wave data based on reflected waves of radio waves emitted after the abnormality detection unit 133 detects an abnormality in the detection result. In the first recovery process, the recover unit 134 updates the first reference data 120 based on the new reflected wave data generated by the generation unit 131. Even when the first reference data 120 is updated, the emittance conditions and reception conditions of radio waves do not change, resulting in no influence on the generation of reflected wave data.

Reflected wave data abnormalities and detection state abnormalities may be resolved by updating the first reference data 120. In the example illustrated in FIGS. 7A, 7B and 7C, with the use of new second reference data 220, which is the first reference data 120 illustrated in FIG. 6 appended with the information of the detected object 700A, it may be possible to normally detect the pedestrian 31b. For this reason, the recover unit 134 generates the second reference data 220 based on the new reflected wave data generated after the detection of an abnormality.

The reflected wave data used to update the first reference data 120 may be generated based on reflected waves obtained from the detection area 400 while there are no moving objects in the detection area 400. For example, reflected wave data may be generated multiple times after an abnormality is detected, and, among these items of reflected wave data, one with the smallest number of detected objects may be selected as the second reference data 220. In another example, multiple items of reflected wave data generated after an abnormality is detected may be combined to generate the second reference data 220. In yet another example, moving objects may be detected based on a difference between the first reference data 120 before the update and the new reflected wave data, and the detected moving objects may be removed from the new reflected wave data to generate the second reference data 220.

If the abnormality detection unit 133 detects a module abnormality, the recover unit 134 performs a partial reset process of resetting the circuit in which the abnormality occurred, among the transmission circuit 114, the reception circuit 115, and the clock generation circuit 117, in the second restoration process. In the partial reset process, a reset is commanded to the circuit to be reset. The circuit receiving the reset command resets itself.

If, as a result of executing the partial reset process, the abnormality of the circuit that has been reset remains unresolved, the recover unit 134 performs an entire reset process of resetting the entire infrastructure radio wave sensor 100. In the entire reset process, the processor 111 illustrated in FIG. 3 (but excluding some of the control circuitry such as a sub-processor), the transmission circuit 114, the reception circuit 115, the volatile memory 113, the communication I/F 116, and the LEDs 118a, 118b, 118c, and 118d are reset. The power supply of the infrastructure radio wave sensor 100 is maintained to be ON. Some of the control circuitry of the processor 111, the clock generation circuit 117, and the non-volatile memory 112 are not reset. When the entire reset process is performed, the processing is resumed from S107, which will be described later, with some of the control circuitry of the processor 111 cooperating with the processor 111.

In response to execution of the recovery process, the determination unit 135 determines whether or not the recovery from the abnormality has succeeded. The determination process performed by the determination unit 135 may be the same as or similar to the abnormality detection process performed by the abnormality detection unit 133 described above.

The determination unit 135 can execute a first determination process and a second determination process. The first determination process is a process of determining whether or not the recovery from the abnormality has failed based on the reflected wave data generated by the generation unit 131 since execution of the first restoration process. For example, the determination unit 135 analyzes the reflected wave data generated by the generation unit 131 after execution of the first recovery process. The determination unit 135 determines that the recovery from the abnormality has failed if the signal level of the reflected waves in at least a portion of the reflected wave data continues, for a certain period, to be the first value or more or the second value or less. The determination unit 135 determines that the recovery from the abnormality has not failed if the signal level of the reflected waves in all of the reflected wave data continues, for a certain period, to exceed the second value and is less than the first value. The second value is a value less than the first value.

In the first determination process, if it is determined that the recovery from the abnormality has not failed, the determination unit 135 executes the second determination process. The second determination process is a process of determining whether or not the recovery from the abnormality has succeeded based on a detection result obtained by the object detection unit 132 after execution of the first restoration process.

For example, the determination unit 135 compares the number of object detections per unit time (e.g., one hour) by the object detection unit 132 after execution of the first restoration process with past performance values to determine whether or not the recovery from the abnormality has succeeded. The determination unit 135 determines that the recovery from the abnormality has failed if the number of object detections per unit time differs from the performance values by a certain amount or more. The determination unit 135 determines that the recovery from the abnormality has succeeded if the number of object detections per unit time falls within a certain range from the past performance values. The past performance values are obtained from the detection result DB 121.

The determination unit 135 may compare a detection result obtained by the object detection unit 132 after execution of the first restoration process with the past performance values in the same time period as the time period in which the detection result was obtained, and determine whether or not the recovery from the abnormality has succeeded. Furthermore, the determination unit 135 may compare a detection result obtained by the object detection unit 132 after execution of the first restoration process with the past performance values on the same day of the week as the day on which the detection result was obtained, and determine whether or not the recovery from the abnormality has succeeded.

The determination unit 135 may determine whether or not the recovery from the abnormality has succeeded based on whether or not the state in which the number of object detections per unit time by the object detection unit 132 is a certain value or more continues for a certain period (e.g., one day) after execution of the first recovery process. If the state in which the number of object detections is a certain value or more continues for a certain period, the determination unit 135 can determine frequent or sustained object detection states and determine that the recovery from the abnormality has failed. If the state in which the number of object detections is a certain value or more does not continue for a certain period, the determination unit 135 can determine that the recovery from the abnormality has succeeded.

The determination unit 135 may determine whether or not the recovery from the abnormality has succeeded based on whether or not the state in which the number of object detections per unit time by the object detection unit 132 is a certain value or less continues for a certain period (e.g., one day) after execution of the first recovery process. If the state in which the number of object detections is a certain value or less continues for a certain period, the determination unit 135 can determine frequent or sustained object undetected states and determine that the recovery from the abnormality has failed. If the state in which the number of object detections is a certain value or less does not continue for a certain period, the determination unit 135 can determine that the recovery from the abnormality has succeeded.

The determination unit 135 may determine whether or not the recovery from the abnormality has succeeded based on whether or not the number of object detections per unit time by the object detection unit 132 falls within a certain range for a certain period (e.g., one day) after execution of the first recovery process. If the number of object detections falls within a certain range for a certain period, the determination unit 135 determines that the number of detections remains unchanged and determines that the recovery from the abnormality has failed. If the number of object detections deviates from a certain range for a certain period, the determination unit 135 can determine that the recovery from the abnormality has succeeded.

In the event that a module abnormality is detected, the determination unit 135 determines whether or not the recovery from the abnormality has succeeded after execution of the partial reset process. The determination unit 135 checks the state information of the circuit that has been reset after the partial reset process has been executed. If the state information represents an abnormality, the determination unit 135 determines that the recovery from the abnormality has failed. In this case, the recover unit 134 executes the entire reset process of the infrastructure radio wave sensor 100. If the state information represents normalcy, the determination unit 135 determines that the recovery from the abnormality has succeeded.

The determination unit 135 determines whether or not the recovery from the abnormality has succeeded after execution of the entire reset process of the infrastructure radio wave sensor 100. The determination unit 135 checks the state information of the circuit where the partial reset was performed after execution of the entire reset process. If the state information represents an abnormality, the determination unit 135 determines that the recovery from the abnormality has failed. If the state information represents normalcy, the determination unit 135 determines that the recovery from the abnormality has succeeded.

The notification unit 136 notifies the user of the determination result obtained by the determination unit 135. The notification unit 136 notifies the user that the recovery from the abnormality has failed if the determination unit 135 determines that the recovery from the abnormality has failed.

The notification unit 136 includes, for example, the LEDs 118a, 118b, 118c, and 118d. If the determination unit 135 determines that the recovery from the abnormality has failed, the notification unit 136 causes the LED 118d to emit light. If the determination unit 135 determines that the recovery from the abnormality has succeeded, the notification unit 136 causes the LED 118a to emit light.

The notification unit 136 includes, for example, the communication I/F 116. If the determination unit 135 determines that the recovery from the abnormality has failed, the notification unit 136 transmits notification information to an external apparatus to notify that the recovery from the abnormality has failed. The external apparatus is, for example, the control apparatus 200. The control apparatus 200 is provided with LEDs for notifying the user of the state of the infrastructure radio wave sensor 100, and the control apparatus 200 controls the LEDs according to the received notification information. The external apparatus may be a terminal used by the user. The terminal receives the notification information and displays information on its screen to notify the user that the recovery from the abnormality has failed according to the notification information. If the determination unit 135 determines that the recovery from the abnormality has succeeded, the notification unit 136 may transmit notification information to the external apparatus to notify the user that the infrastructure radio wave sensor 100 is functioning normally. The external apparatus illuminates its LED or displays a screen according to the received notification information.

If it is determined in the first determination process that the recovery from the abnormality has failed, or if it is determined in the second determination process that the recovery from the abnormality has failed, the notification unit 136 is able to notify the user that the recovery from the abnormality has failed, as described above.

The notification unit 136 notifies the user that a recovery operation from the abnormality is in progress during execution of the second determination process. For example, during execution of the second determination process, the notification unit 136 causes the LED 118c to emit light. The notification unit 136 may, during execution of the second determination process, transmit notification information to the external apparatus to notify that the recovery operation from the abnormality is in progress. During execution of the first determination process and execution of the second determination process, the notification unit 136 may illuminate the LED 118c or transmit notification information to the external apparatus.

The notification unit 136 notifies the user that the partial reset process is in progress during execution of the partial reset process of the circuit in which a module abnormality occurred. For example, during execution of the partial reset process, the notification unit 136 causes the LED 118b to emit light. During execution of the partial reset process, the notification unit 136 may transmit notification information to the external apparatus to notify that the partial reset process is in progress.

When the entire reset process of the infrastructure radio wave sensor 100 is to be executed, the notification unit 136 may notify the user that the entire reset process is to be executed. For example, when the entire reset process is to be executed, the notification unit 136 may transmit notification information to the external apparatus to notify that the entire reset process is to be executed.

When the abnormality detection unit 133 detects an abnormality, the record unit 137 records abnormality information regarding the abnormality. For example, the record unit 137 stores state information of the infrastructure radio wave sensor 100 in the log DB 122. When the abnormality detection unit 133 detects an abnormality, the record unit 137 stores abnormality information including the date and time of occurrence of the abnormality and the type of the abnormality (e.g., a reflected wave data abnormality, a detection state abnormality, or a module abnormality) in the log DB 122.

When recovery from the abnormality is performed by the recover unit 134, the record unit 137 records abnormal information including the method of recovery. For example, if the determination unit 135 determines that the recovery from the abnormality has succeeded, the record unit 137 may record abnormal information including the method of recovery. For example, if the update of the reference data succeeds in recovering from the abnormality, the record unit 137 stores abnormality information including the update of the reference data as the method of recovery in the log DB 122. For example, if the partial reset process succeeds in recovering from the abnormality, the record unit 137 stores abnormality information including the partial reset process as the method of recovery in the log DB 122. In this case, the abnormality information may include information identifying the circuit where the partial reset was performed. For example, if the entire reset process succeeds in recovering from the abnormality, the record unit 137 stores abnormality information including the entire reset process as the method of recovery in the log DB 122.

### [4. Operation of Infrastructure Radio Wave Sensor]

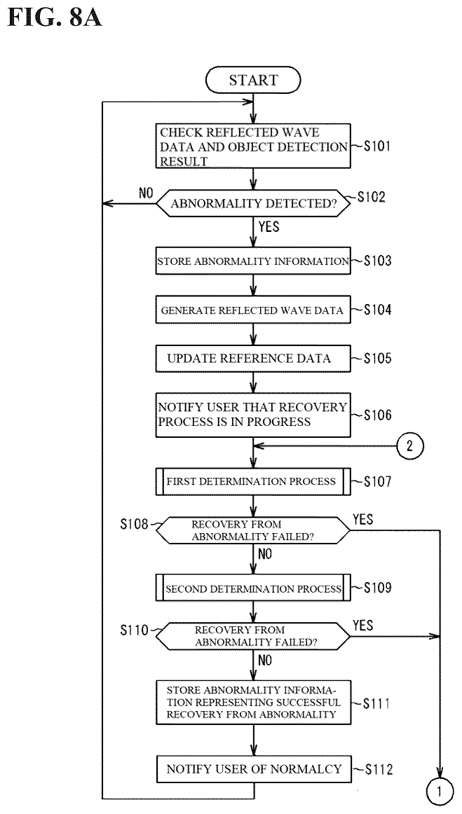

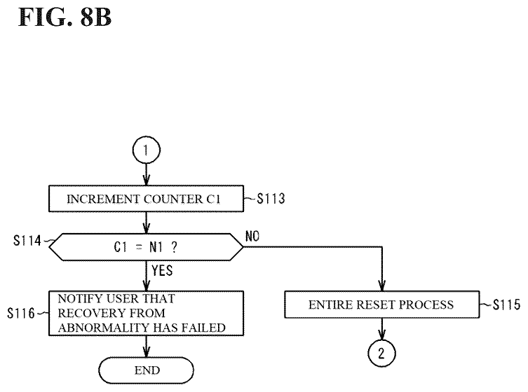

FIGS. 8A and 8B are flowcharts illustrating an example of a process of determining a reflected wave data abnormality or a detection state abnormality by the infrastructure radio wave sensor according to the present embodiment. This process is implemented by the control program 119. When starting this process, the counter C1 is initialized to zero.

The processor 111 checks the reflected wave data and object detection result (step S101). Specifically, as described above, the processor 111 determines whether or not the signal level of the reflected waves in at least a portion of the reflected wave data continues, for a certain period of time, to be the first value or more or the second value or less to detect a reflected wave data abnormality. The processor 111 further compares the number of object detections per unit of time (e.g., one hour) with past performance values to detect a detection state abnormality.

The processor 111 determines whether or not an abnormality (a reflected wave data abnormality or a detection state abnormality) has been detected (step S102). If no abnormality has been detected (NO in step S102), the processor 111 returns to step S101.

If an abnormality has been detected (YES in step S102), the processor 111 stores abnormality information representing that the abnormality has been detected in the log DB 122 (step S103).

The processor 111 controls the transmission circuit 114 and the reception circuit 115. This causes modulated waves to be transmitted from the transmission antenna 114a, and reflected waves to be received by the reception antenna 115a. The processor 111 combines the modulated wave signal output from the transmission circuit 114 with the reflected wave signal output from the reception circuit 115 to generate an IF signal. The processor 111 applies signal processing such as FFT on the IF signal to obtain distance, velocity, and azimuth information, and generates reflected wave data (step S104). The processor 111 updates the first reference data 120 based on the generated reflected wave data (step S105).

The processor 111 illuminates the LED 118c and transmits notification information to the external apparatus to notify the user that the recovery operation from the abnormality is in progress (step S106).

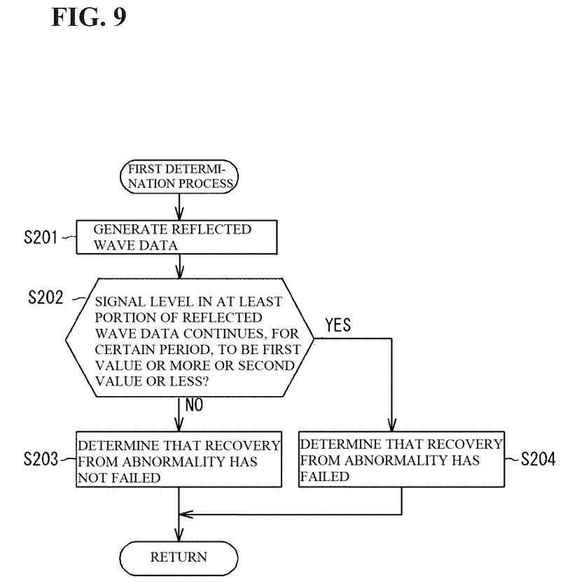

The processor 111 executes the first determination process (step S107). FIG. 9 is a flowchart illustrating an example of the first determination process.

The processor 111 generates reflected wave data by performing the processing identical or similar to step S104 (step S201).

The processor 111 then analyzes the reflected wave data to determine whether or not the signal level in at least a portion of the reflected wave data continues, for a certain period, to be the first value or more or the second value or less (step S202).

If the signal level of the reflected waves in all of the reflected wave data continues, for a certain period, to exceed the second value and to fall below the first value (NO in step S202), the processor 111 determines that the recovery from the abnormality has not failed (step S203). For example, since the update of the reference data does not affect the generation of the reflected wave data, if the cause that was affecting the reception state of the radio waves (for example, an object such as a bird was temporarily present just in front of the transmission and reception surface 101) is eliminated, the signal level of the reflected waves will drop from a value that is the first value or more. In such a case, the infrastructure radio wave sensor 100 naturally recovers from the abnormality, and it is determined in step S203 that the recovery from the abnormality has not failed. If the signal level in at least a portion of the reflected wave data continues, for a certain period, to be the first value or more or the second value or less (YES in step S202), the processor 111 determines that the recovery from the abnormality has failed (step S204). At this point, the first determination process ends.

Referring back to FIG. 8A, the processor 111 determines in the first determination process whether or not the recovery from the abnormality has been determined to have failed (step S108).

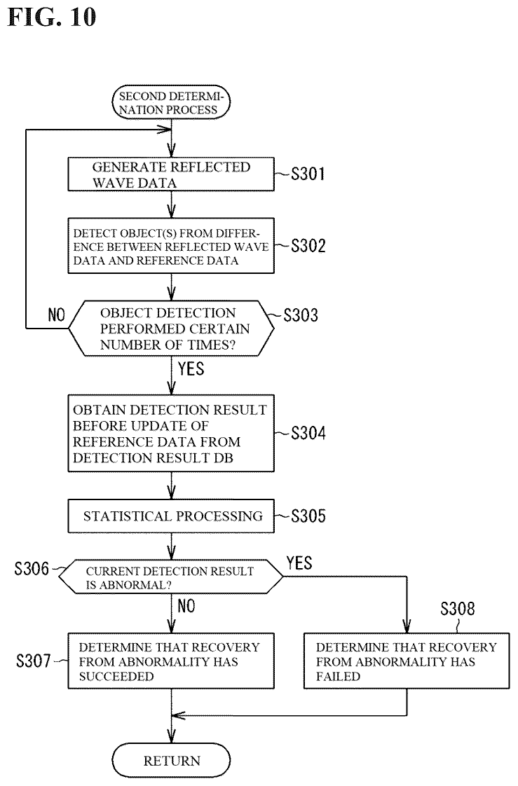

If it is determined in the first determination process that the recovery from the abnormality has not failed (NO in step S108), the processor 111 executes the second determination process (step S109). FIG. 10 is a flowchart illustrating an example of the second determination process.

The processor 111 generates reflected wave data by performing the processing identical or similar to step S104 (step S301). The processor 111 calculates the difference between the reflected wave data and the first reference data 120 to detect one or more objects (step S302). Hereinafter, the number of object detections calculated by step S302 is referred to as the “current value of the number of object detections”. The processor 111 determines whether or not object detection has been performed a certain number of times by steps S301 and S302 (step S303) If object detection has not been performed the certain number of times (NO in step S303), the processor 111 returns to step S301 and performs object detection again.

If object detection has been performed the certain number of times (YES in step S303), the processor 111 obtains the detection result of the infrastructure radio wave sensor 100 before updating the first reference data 120 from the detection result DB 121 (step S304). Hereinafter, the number of object detections obtained from the detection result DB 121 is referred to as the “performance value of the number of object detections”. The processor 111 performs certain statistical processing on each of the current and performance values of the number of object detections (step S305). The statistical processing is, for example, time averaging.

The processor 111 determines whether or not the current (after updating the first reference data 120) object detection result is abnormal (step S306). In step S306, for example, the processor 111 compares the current value of the number of object detections after the statistical processing with the performance value, and determines that the current object detection result is abnormal if the difference between the current value and the performance value of the number of object detections is a certain value or more. For example, the processor 111 can also determine that the current object detection result is abnormal if the state where the number of object detections after the update of the first reference data 120 is the certain value or more continues for a certain period. For example, the processor 111 can also determine that the current object detection result is abnormal if the state where the number of object detections after the update of the first reference data 120 is zero continues for a certain period. For example, the processor 111 can also determine that the current object detection result is abnormal if the number of object detections after the update of the first reference data 120 falls within a certain range for a certain period.

If the current object detection result is normal (NO in step S306), the processor 111 determines that the recovery from the abnormality has succeeded (step S307). If the current object detection result is abnormal (YES in step S306), the processor 111 determines that the recovery from the abnormality has failed (step S307). At this point, the second determination process ends.

Referring back to FIG. 8A, the processor 111 determines in the second determination process whether or not the recovery from the abnormality has been determined to have failed (step S110).

If it is determined in the second determination process that the recovery from the abnormality has succeeded (NO in step S110), the processor 111 stores abnormality information representing that the recovery from the abnormality has succeeded in the log DB 122 (step S111). The abnormality information includes information representing the update of the reflected wave data as the method of recovery from the abnormality.

The processor 111 illuminates the LED 118a and transmits notification information to the external apparatus to notify the user that the recovery from the abnormality has succeeded (step S112). Accordingly, one cycle of the process of determining a reflected wave data abnormality or a detection state abnormality ends, and the process returns to step 101.

In the first determination process or the second determination process, if it is determined that the recovery from the abnormality has failed (YES in step S108 or step S110), the processor 111 increments the counter C1 by one (step S113).

The processor 111 determines whether or not C1 is equal to the certain value N1 (step S114). N1 may be 1, or 2 or more. If C1 is less than N1 (NO in step S114), the processor 111 executes the entire reset process of the infrastructure radio wave sensor 100 (step S115), and returns to step S107. This causes the process from step S107 onward to be executed again.

If C1 is equal to N1 (YES in step S114), the recovery from the abnormality has failed N1 time(s). In this case, the processor 111 illuminates the LED 118d and transmits notification information to the external apparatus to notify the user that the recovery from the abnormality has failed (step S116). At this point, the process of determining a reflected wave data abnormality or a detection state abnormality ends.

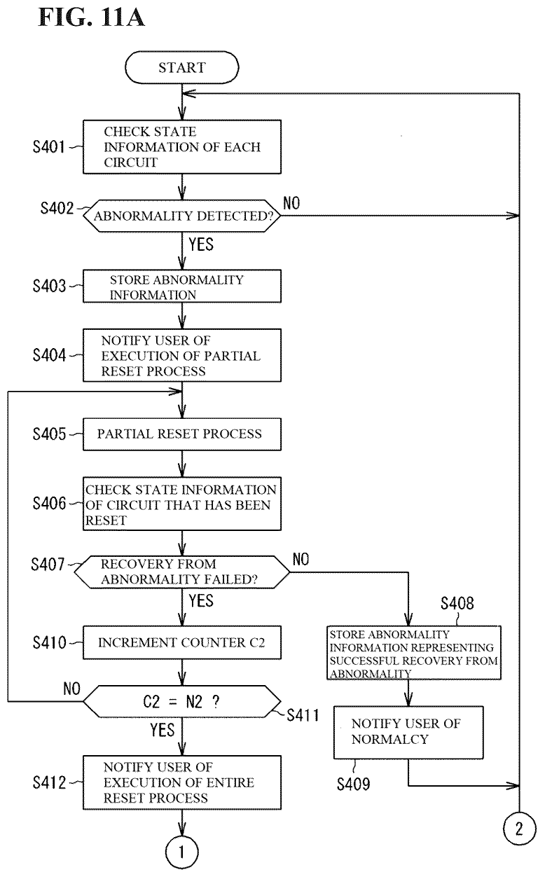

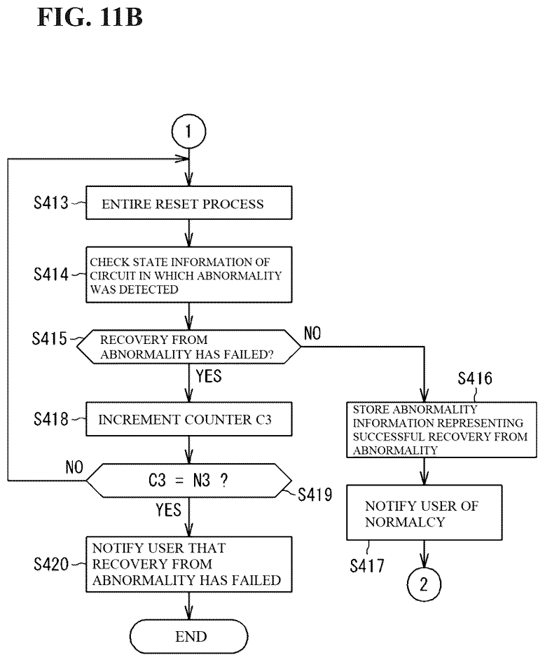

FIG. 11A and FIG. 11B are flowcharts each illustrating an example of a module abnormality determination process by the infrastructure radio wave sensor according to the present embodiment. This process is implemented by the control program 119. When starting this process, counters C2 and C3 are each initialized to zero.

The processor 111 checks the state information of the transmission circuit 114, the reception circuit 115, and the clock generation circuit 117 (step S401).

The processor 111 determines whether or not an abnormality (module abnormality) has been detected in any of the transmission circuit 114, the reception circuit 115, and the clock generation circuit 117 (step S402). If no abnormality has been detected (NO in step S402), the processor 111 returns to step S401.

If an abnormality has been detected (YES in step S402), the processor 111 stores abnormality information representing that the abnormality has been detected in the log DB 122 (step S403).

The processor 111 illuminates the LED 118b and transmits notification information to the external apparatus to notify the user that the partial reset process is in progress (step S404).

The processor 111 executes the partial reset process and outputs a reset command to the circuit where the abnormality was detected (step S405). The circuit receiving the command resets itself.

The processor 111 checks the state information of the circuit that has been reset (step S406).

The processor 111 determines whether or not the recovery from the abnormality has failed based on the state information (step S407). In other words, the processor 111 determines that the recovery from the abnormality has failed if the circuit that has been reset is in the abnormal state, and determines that the recovery from the abnormality has succeeded if the circuit that has been reset is in the normal state.

If it is determined that the recovery from the abnormality has succeeded (NO in step S407), the processor 111 stores abnormality information representing that the recovery from the abnormality has succeeded in the log DB 122 (step S408). The abnormality information includes information representing the partial reset as the method of recovery from the abnormality.

The processor 111 illuminates the LED 118a and transmits notification information to the external apparatus to notify the user that the recovery from the abnormality has succeeded (step S409). The processor 111 then returns to step S401.

If it is determined that the recovery from the abnormality has failed (YES in step S407), the processor 111 increments the counter C2 by one (step S410).

The processor 111 determines whether C2 is equal to the certain value N2 (step S411). N2 may be 1, or 2 or more. If C2 is less than N2 (NO in step S411), the processor 111 returns to step S405. This causes the partial reset process to be executed again.

If C2 is equal to N2 (YES in step S411), the recovery from the abnormality has failed even with the partial reset performed N2 time(s). In this case, the processor 111 transmits notification information to the external apparatus to notify the user to execute the entire reset process (step S412). The processor 111 executes the entire reset process of the infrastructure radio wave sensor 100 (step S413).

The processor 111 checks the state information of the circuit in which the abnormality was detected (step S414). The processor 111 determines whether or not the recovery from the abnormality has failed based on the state information (step S415). In other words, the processor 111 determines that the recovery from the abnormality has failed if the state of the circuit in which the abnormality was detected remains abnormal, and determines that the recovery from the abnormality has succeeded if the state of the circuit has returned to normal.

If it is determined that the recovery from the abnormality has succeeded (NO in step S415), the processor 111 stores abnormality information representing that the recovery from the abnormality has succeeded in the log DB 122 (step S416). The abnormality information includes information representing the entire reset as the method of recovery from the abnormality.

The processor 111 illuminates the LED 118a and transmits notification information to the external apparatus to notify the user that the recovery from the abnormality has succeeded (step S417). The processor 111 then returns to step S401.

If it is determined that the recovery from the abnormality has failed (YES in step S415), the processor 111 increments the counter C3 by one (step S418).

The processor 111 determines whether C3 is equal to the certain value N3 (step S419). N3 may be 1, or 2 or more. If C3 is less than N3 (NO in step S419), the processor 111 returns to step S413. This causes the entire reset process to be executed again.

If C3 is equal to N3 (YES in step S419), the recovery from the abnormality has failed even with the entire reset performed N3 time(s). In this case, the processor 111 illuminates the LED 118d and transmits notification information to the external apparatus to notify the user that the recovery from the abnormality has failed (step S420). At this point, the module abnormality determination process ends.

### [5. Modifications]

In the above-described embodiment, the process of determining a reflected wave data abnormality or a detection state abnormality includes, but is not limited to, the first determination process and the second determination process. The process of determining a reflected wave data abnormality or a detection state abnormality may include only the first determination process. In the above-described embodiment, the first determination process determines whether the recovery from the abnormality has failed or not. In a modification, a state in which recovery from the abnormality has not failed is determined to have a high probability of successful recovery from the abnormality. In other words, the processor 111 can determine whether the recovery from the abnormality has succeeded or failed in the first determination process.

The process of determining a reflected wave data abnormality or a detection state abnormality may include only the second determination process.

In other words, the processor 111 can determine whether the recovery from the abnormality has succeeded or failed in the second determination process.

The embodiment disclosed herein is exemplary in all respects and is not limiting. The scope of the invention is indicated by the scope of the claims, not by the above-described embodiment, and includes all changes within the meaning and scope of the claims and equivalents thereof.

### REFERENCE SIGNS LIST

10 traffic monitoring system (object detection system)
20 road
31, 31a, and 31b pedestrians
32 vehicle
100 infrastructure radio wave sensor
101 transmission and reception surface
102 sensor body
103 depression angle adjustment unit
104 horizontal angle adjustment unit
105 roll angle adjustment unit
111 processor
112 non-volatile memory
113 volatile memory
114 transmission circuit
114a transmission antenna
115 reception circuit
115a reception antennas
116 communication interface (communication I/F)
117 clock generation circuit
118a, 118b, 118c, and 118d LEDs
119 control program
120 first reference data
220 second reference data
121 detection result database (detection result DB)
122 log database (log DB)
131 generation unit
132 object detection unit
133 abnormality detection unit
134 recover unit
135 determination unit
136 notification unit
137 record unit
200 control apparatus
310 pole
320 arm
400 detection area
501 traffic light and plant
502 building
503 traffic light
504 plant
501A, 502A, 503A, 504A, 601A, 602A, and 700A detected objects
700 construction vehicle

1. An infrastructure radio wave sensor comprising:
circuitry configured to
based on reflected waves that are radio waves emitted to a first object that is constantly present and a second object different from the first object and that are reflected from the first object and the second object, generate first reflected wave data representing information including a signal level of the reflected waves;
detect the second object based on reference data representing information including a position of the first object and the first reflected wave data;
detect a first abnormality that is an abnormality in a detection result obtained by the circuitry; and
in a case where the first abnormality is detected, control execution of a recovery process to recover from the first abnormality,
wherein the circuitry generates second reflected wave data based on reflected waves of radio waves emitted after the first abnormality is detected, and
the circuitry updates the reference data based on the second reflected wave data.

2. The infrastructure radio wave sensor according to claim 1,
wherein the circuitry is configured to, in a case where the recovery process is executed, execute a second determination process that determines whether recovery from the first abnormality has succeeded or failed.

3. The infrastructure radio wave sensor according to claim 2, wherein:
the circuitry is further configured to determine, in the second determination process, whether the recovery from the first abnormality has succeeded or not, based on a detection result before the reference data is updated and a detection result after the reference data is updated.

4. The infrastructure radio wave sensor according to claim 2, wherein:
the circuitry is further configured to execute a first determination process of determining whether the recovery from the first abnormality has failed or not, based on third reflected wave data newly generated by the circuitry since execution of the recovery process, and
execute the second determination process in a case where it is determined in the first determination process that the recovery from the first abnormality has not failed.

5. The infrastructure radio wave sensor according to claim 4, wherein:
the circuitry is further configured to determine, in the first determination process, that the recovery from the first abnormality has failed in a case where a signal level of reflected waves in at least a portion of the third reflected wave data continuous, for a certain period of time, to be a first value or more or a second value or less.

6. The infrastructure radio wave sensor according to claim 1, further comprising:
a plurality of modules,
wherein the the circuitry is further configured to detect a second abnormality that is an abnormality in at least one or some of the plurality of modules, and
in a case where the circuitry detects the second abnormality, the circuitry is configured to execute a partial reset process of resetting the module(s) in which the second abnormality has been detected.

7. The infrastructure radio wave sensor according to claim 6, wherein:
the circuitry is further configured to execute an entire reset process of resetting the entire infrastructure radio wave sensor in a case where the second abnormality is not resolved after the partial reset process.

8. The infrastructure radio wave sensor according to claim 6, wherein:
the plurality of modules include a transmission circuit configured to transmit the radio waves, a reception circuit configured to receive the reflected waves, and a clock generation circuit configured to transmit a clock signal to the transmission circuit and the reception circuit.

9. The infrastructure radio wave sensor according to claim 1, further comprising:
a memory configured to, in a case where the circuitry detects an abnormality including at least one of the first abnormality or the second abnormality, record abnormality information regarding the abnormality,
wherein the memory is configured to record the abnormality information including a method of recovery in a case where recovery from the abnormality is performed by the circuitry.

10. The infrastructure radio wave sensor according to claim 2, wherein the circuitry is further configured to
in a case where the circuitry determines that the recovery from the abnormality has failed, notify a user that the recovery from the abnormality has failed.

11. The infrastructure radio wave sensor according to claim 4, wherein:
the circuitry is configured to
notify the user of an occurrence of the first abnormality,
notify the user that a recovery operation from the first abnormality is in progress during execution of the second determination process, and
notify the user that the recovery from the first abnormality has failed in a case where it is determined in the first determination process that the recovery from the first abnormality has failed or in a case where it is determined in the second determination process that the recovery from the first abnormality has failed.

12. The infrastructure radio wave sensor according to claim 4, wherein:
the circuitry is configured to notify the user of a normal state in a case where it is determined in the second determination process that the recovery from the first abnormality has succeeded.

13. The infrastructure radio wave sensor according to claim 6,
the circuitry is further configured to notify a user of an occurrence of the second abnormality,
wherein the circuitry is configured to notify the user that the partial reset process is in progress during execution of the partial reset process.

14. The infrastructure radio wave sensor according to claim 3, wherein:
the circuitry is configured to
execute a first determination process of determining whether the recovery from the first abnormality has failed or not, based on third reflected wave data newly generated by the circuitry since execution of the recovery process, and
execute the second determination process in a case where it is determined in the first determination process that the recovery from the first abnormality has not failed.

15. The infrastructure radio wave sensor according to claim 2, further comprising:
a plurality of modules,
wherein the circuitry is further configured to detect a second abnormality that is an abnormality in at least one or some of the plurality of modules, and
in a case where the circuitry detects the second abnormality, the circuitry is configured to execute a partial reset process of resetting of any module of the plurality of modules in which the second abnormality has been detected.

16. The infrastructure radio wave sensor according to claim 3, further comprising:
a plurality of modules,
wherein the circuitry is further configured to detect a second abnormality that is an abnormality in at least one or some of the plurality of modules, and
in a case where the circuitry detects the second abnormality, the circuitry is configured to execute a partial reset process of resetting of any module of the plurality of modules in which the second abnormality has been detected.

17. The infrastructure radio wave sensor according to claim 4, further comprising:
a plurality of modules,
wherein the circuitry is further configured to detect a second abnormality that is an abnormality in at least one or some of the plurality of modules, and
in a case where the circuitry detects the second abnormality, the circuitry is configured to execute a partial reset process of resetting of any module of the plurality of modules in which the second abnormality has been detected.

18. The infrastructure radio wave sensor according to claim 5, further comprising:
a plurality of modules,
wherein the circuitry is further configured to detect a second abnormality that is an abnormality in at least one or some of the plurality of modules, and
in a case where the circuitry detects the second abnormality, the circuitry is configured to execute a partial reset process of resetting of any module of the plurality of modules in which the second abnormality has been detected.

19. The infrastructure radio wave sensor according to claim 7, wherein:
the plurality of modules include a transmission circuit configured to transmit the radio waves, a reception circuit configured to receive the reflected waves, and a clock generation circuit configured to transmit a clock signal to the transmission circuit and the reception circuit.

20. The infrastructure radio wave sensor according to claim 2, further comprising:
a memory configured to, in a case where the circuitry detects an abnormality including at least one of the first abnormality or the second abnormality, record abnormality information regarding the abnormality,
wherein the memory is configured to record the abnormality information including a method of recovery in a case where recovery from the abnormality is performed by the memory.
